(19) United States
(12) Patent Application Publication
(10) Pub. No.: US 2012/0229564 A1
(43) Pub. Date: Sep. 13, 2012

(54) INKJET PRINT HEAD WIPER FOR PARTIALLY WETTING AND ANTI-WETTING NOZZLE SURFACES, CLEANING UNIT AND AN INKJET PRINTER COMPRISING SAID WIPER

(76) Inventor: Alex N. WESTLAND, Baarlo (NL)

(21) Appl. No.: 13/477,553

(22) Filed: May 22, 2012

Related U.S. Application Data
(63) Continuation of application No. PCT/EP2010/067921, filed on Nov. 22, 2010.

(30) Foreign Application Priority Data
Nov. 23, 2009 (EP) 09176734.3

(51) Int. Cl. B41J 2/165

(52) U.S. Cl. 347/33

(57) ABSTRACT

In a printer, an inkjet print head is equipped with a wiper for partially wetting and non-wetting nozzle faces, for wiping excess ink off a nozzle face, wherein the wiping surface is shaped such that the wiping surface in operation contacts the wetting area and such that the wiping surface in operation is arranged at a predetermined distance from the non-wetting area. A printer including the wiper is also provided.

### CROSS-REFERENCE TO RELATED APPLICATIONS

This application is a Continuation of International Application No. PCT/EP2010/067921, filed on Nov. 22, 2010, and for which priority is claimed under 35 U.S.C. §120, and which claims priority under 35 U.S.C. §119 to Application No. 09176734.3, filed on Nov. 23, 2009. The entirety of each of the above-identified applications is expressly incorporated herein by reference.

### BACKGROUND OF THE INVENTION

1. Field of the Invention

The present invention relates to an inkjet print head wiper for wiping excess ink off a nozzle surface. The present invention further relates to a printer comprising said wiper.

2. Background of the invention:

In a known inkjet printer, a print head comprises a nozzle surface, having arranged therein at least one nozzle. Ink is ejected from the print head through said nozzle. When printing, ink may be spilled on the nozzle surface of the print head. Ink present on the nozzle surface close to a nozzle may have a negative influence on the performance of a print head during jetting of the ink. Therefore, it is important to prevent presence of ink close to a nozzle.

It is known to prevent ink to be present close to a nozzle by applying an anti-wetting coating around a nozzle. This prevents the formation of an ink film Instead, ink that comes into contact with the anti-wetting coating will form a droplet, having a relatively small contact area with the coating. However, absent any driving force, the droplets may stay on the anti-wetting coating. If a droplet is present on the anti-wetting coating near the nozzle, this may still have a negative influence on the jetting. Therefore, ink droplets present on the nozzle face on an anti-wetting coating may still be needed to be removed.

It is known to remove ink by wiping. However, wiping may damage the anti-wetting coating.

WO 2008/079878 discloses a wiper for a nozzle surface that comprises a wetting area. In WO 2008/079878, a nozzle surface contains a faceplate attached to the outer edges of the nozzle surface. The faceplate is shaped such that it leaves a substantial portion of the nozzle surface exposed, wherein the exposed portion comprises the nozzles and is recessed relative to the surface of the faceplate. The wiper moves across the faceplate. In this way, the faceplate prevents the wiper from contacting the nozzle surface, thereby preventing wear on a nozzle surface and damage to a coating. However, because of the presence of the faceplate attached to the outer edges, the ink that is wiped away from the nozzles builds up at the outer edges of the nozzle plate, being bound by the faceplate.

### SUMMARY OF THE INVENTION

It is an object of the present invention to provide a wiper for wiping a nozzle face, which does not contact a coating on the nozzle face, while enabling to wipe away any ink on the nozzle surface.

The object is achieved in a wiper for wiping a nozzle surface, the nozzle surface comprising a wetting area and an anti-wetting area, the wiper having a wiper area, the wiper area being shaped such that it comprises a first wiper subarea that in operation contacts at least a part of the wetting area and a second wiper subarea that in operation is arranged at a predetermined distance from the anti-wetting area.

The anti-wetting area of the nozzle surface is the part of the nozzle surface, where the nozzle surface is not wetted by the ink. The anti-wetting area is assumed to be provided by using an anti-wetting coating.

The wetting area of the nozzle surface is the part of the nozzle surface, where the nozzle surface is wetted by the ink. The wetting area is assumed to be provided by omission of any coating.

The wiper area is the area of the wiper that performs the actual wiping. The wiper area comprises a plurality of wiper subareas. The first wiper subarea contacts in operation at least a part of the wetting area and may thus remove ink from the surface of the nozzle surface. The second wiper subarea is in operation arranged at a predetermined distance from the anti-wetting area and does not contact the anti-wetting area. Since the wiper does not contact the anti-wetting coating, the coating is not damaged by wiping, but still, excess ink may be removed from the nozzle surface by the first wiper subarea, wiping the wetting area.

The wiper is an object, which may remove contamination from a surface or an object, e.g. a nozzle surface by mechanical movement. The wiper may move along an object or surface and may remove contamination from (at least a part of) the surface or object. The contamination may be, e.g. ink or dust.

In an embodiment, the predetermined distance is such that a droplet present on the anti-wetting area of the nozzle surface is in operation removed by wiping with said wiper. In case ink is positioned on an anti-wetting surface, the contact surface between the ink and the surface on which it is positioned is small. Thus, the ink forms a droplet. This droplet extends in a direction perpendicular to the anti-wetting surface. The second wiper subarea is arranged at a certain predetermined distance from the nozzle surface. The predetermined distance is less than the height of a droplet. Hence, during wiping, the second wiper subarea may engage a part of the droplet. Due to the properties of the anti-wetting area, the droplet moves with the wiper. Consequently, the anti-wetting area may also be efficiently wiped and excess ink may also be removed.

In an embodiment, the wiper has a wiper surface, the wiper surface having a length and a width, the length extending in operation substantially parallel to the nozzle surface and the width extending perpendicular to the length, wherein the width of the wiper surface of the second wiper subarea is smaller than the width of the wiper surface of the first wiper subarea.

The difference in width between the wiper surfaces of the first and second wiper subarea may provide a difference in distance between the first wiper subarea and the nozzle surface on the one hand and the second wiper subarea and the nozzle surface on the other hand. Thus, a shape in accordance with the present invention is efficiently embodied.

In an embodiment, the predetermined distance is adjustable. The wiper according to the present invention may be flexible to some extend and therefore, the first wiper subarea may bend in the direction perpendicular to the length of the wiper, which is oriented parallel with respect to the nozzle surface. As a result, the predetermined distance between the second wiper subarea and the nozzle surface may be adjusted, for example by varying the force applied on the wiper in a direction substantially perpendicular to the nozzle surface.

In an embodiment, the predetermined distance is larger than the height of a droplet of ink on the anti-wetting area. If ink is present near a nozzle, then wiping may result in the ink being wiped into the nozzle. Moreover, any contamination present on the nozzle surface may be wiped into the nozzle. By arranging the second wiper subarea at a predetermined distance that exceeds the height of a droplet (of ink), a droplet of ink may be prevented from being wiped into a nozzle. This prevents negatively influencing the performance (e.g. jetting performance) of the nozzle and still, damage to the coating applied on the nozzle surface is prevented.

In a particular embodiment, the anti-wetting coating is applied with a wetting gradient. The wetting gradient, as is known e.g. from EP 2072262 A1, may be provided by applying a pattern of an anti-wetting coating around a nozzle. Because of this pattern, the wettability is poor near the nozzle and increases with the distance from the nozzle. The increasing wettability with the increasing distance from a nozzle provides a driving force for movement of ink droplets away from the nozzle, towards the wetting area. Once the droplet has reached the wetting area of the nozzle surface, it may be wiped off the nozzle surface by the first wiper subarea.

In an embodiment, the predetermined distance is a first predetermined distance smaller than the height of a droplet of ink on the anti-wetting area and wherein the wiper area further comprises a third wiper subarea arranged at a second predetermined distance from the nozzle surface larger than the height of a droplet of ink. As mentioned above, the wiping surface comprises a plurality of wiper subareas, which may be positioned at different distances from the nozzle surface. A first wiper subarea is positioned at a distance such that it contacts a wetting area of the nozzle surface. A second wiper subarea is positioned at a first predetermined distance from an anti-wetting area of the nozzle surface. In this embodiment, this first predetermined distance is smaller than the height of a droplet and consequently, the second wiper subarea may remove droplets present on the anti-wetting area of the nozzle surface by wiping. In this embodiment, a third wiper subarea is present, positioned at a second predetermined distance from the nozzle surface. The second predetermined distance is larger than the height of a droplet. As a consequence, droplets are not removed by the third wiper subarea when wiping.

This embodiment may be advantageous when an anti-wetting coating is applied on part of a nozzle surface. The second wiper subarea may remove droplets present on this coating. A third wiper area may be positioned such that it traverses in operation over a nozzle. Here, no droplets are removed, thereby preventing the droplets to be wiped into a nozzle.

In an aspect of the invention, a cleaning unit for wiping a nozzle surface is provided, said cleaning unit comprising a positioning device and a wiper, the wiper being adapted for wiping a nozzle surface, the wiper having a wiper area, the wiper area being shaped such that it comprises a first wiper subarea and a second wiper subarea, the positioning device being adapted to position the wiper with respect to the nozzle surface, the positioning device comprising a holder for holding the wiper and positioning said wiper with respect to the nozzle surface, such that in a wiping operation, the first wiper subarea contacts a part of the nozzle surface and such that in operation, the second wiper subarea is arranged at a predetermined distance from another part of the nozzle surface.

In an embodiment, a cleaning unit for wiping a nozzle surface comprising a wetting area and an anti-wetting area is provided, wherein the first wiper subarea in operation contacts at least a part of the wetting area and the second wiper subarea in a wiping operation is arranged at a predetermined distance from at least a part of the anti-wetting area. The wiper area is the area of the wiper that performs the actual wiping. The wiper area comprises a plurality of wiper subareas. The first wiper subarea contacts in operation at least a part of the wetting area and may thus remove ink from the surface of the nozzle surface. The second wiper subarea is in operation arranged at a predetermined distance from the anti-wetting area and does not contact the anti-wetting area. Since the wiper does not contact the anti-wetting coating, the coating is not damaged by wiping, but still, excess ink may be removed from the nozzle surface by the first wiper subarea, wiping the wetting area.

In an embodiment, the wiper is positioned such that the predetermined distance is such that a droplet present on the nozzle surface is in a wiping operation removed by wiping with said wiper. If ink is positioned on an anti-wetting surface, then the contact surface between the ink and the surface on which it is positioned is small. Thus, the ink forms a droplet. This droplet extends in a direction perpendicular to the anti-wetting surface. The second wiper subarea is arranged at a certain predetermined distance from the nozzle surface. The predetermined distance is less than the height of a droplet. Hence, during wiping, the second wiper subarea may engage a part of the droplet. Due to the properties of the anti-wetting area, the droplet moves with the wiper. Consequently, the anti-wetting area may also be efficiently wiped and excess ink may also be removed.

In an embodiment, the wiper has a front surface, the front surface having a length and a width and the positioning device positions the wiper such that the length of the wiper extends in a wiping operation substantially parallel to the nozzle surface and the width of the wiper extends perpendicular to the length, wherein the width of the front surface of the second part of the wiper subarea is smaller than the width of the front surface of the first part of the wiper subarea. The difference in width between the wiper surfaces of the first and second wiper subarea may provide a difference in distance between the first wiper subarea and the nozzle surface on the one hand and the second wiper subarea and the nozzle surface on the other hand. Thus, a shape in accordance with the present invention is efficiently embodied.

In an embodiment, the predetermined distance is adjustable. The wiper according to the present invention may be flexible to some extend and therefore, the first wiper subarea may bend in the direction perpendicular to the length of the wiper, which is oriented parallel with respect to the nozzle surface. In addition, the positioning device may comprise a holder that allows adjustment of the predetermined distance. As a result, the predetermined distance between the second wiper subarea and the nozzle surface may be adjusted, for example by varying the force applied on the wiper in a direction substantially perpendicular to the nozzle surface.

In an embodiment, the predetermined distance is larger than the height of a droplet of ink on the anti-wetting area. If ink is present near a nozzle, then wiping may result in the ink being wiped into the nozzle. Moreover, any contamination present on the nozzle surface may be wiped into the nozzle. By arranging the second wiper subarea at a predetermined distance that exceeds the height of a droplet (of ink), a droplet of ink may be prevented from being wiped into a nozzle. This prevents negatively influencing the performance (e.g. jetting performance) of the nozzle and still, damage to the coating applied on the nozzle surface is prevented.

In an embodiment, the predetermined distance is larger than the height of a droplet of ink on the anti-wetting area. If ink is present near a nozzle, then wiping may result in the ink being wiped into the nozzle. Moreover, any contamination present on the nozzle surface may be wiped into the nozzle. By arranging the second wiper subarea at a predetermined distance that exceeds the height of a droplet (of ink), a droplet of ink may be prevented from being wiped into a nozzle. This prevents negatively influencing the performance (e.g. jetting performance) of the nozzle and still, damage to the coating applied on the nozzle surface is prevented.

In an embodiment, the predetermined distance is a first predetermined distance smaller than the height of a droplet of ink on the anti-wetting area, the wiper further comprises a third wiper subarea and the positioning device positions the wiper such that the third wiper area is arranged at a second predetermined distance from the nozzle surface larger than the height of a droplet of ink. As mentioned above, the wiping surface comprises a plurality of wiper subareas, which may be positioned at different distances from the nozzle surface. A first wiper subarea is positioned at a distance such that it contacts a wetting area of the nozzle surface. A second wiper subarea is positioned at a first predetermined distance from an anti-wetting area of the nozzle surface. In this embodiment, this first predetermined distance is smaller than the height of a droplet and consequently, the second wiper subarea may remove droplets present on the anti-wetting area of the nozzle surface by wiping. In this embodiment, a third wiper subarea is present, positioned at a second predetermined distance from the nozzle surface. The second predetermined distance is larger than the height of a droplet. As a consequence, droplets are not removed by the third wiper subarea when wiping.

This embodiment may be advantageous when an anti-wetting coating is applied on part of a nozzle surface. The second wiper subarea may remove droplets present on this coating. A third wiper area may be positioned such that it traverses in operation over a nozzle. Here, no droplets are removed, thereby preventing the droplets from being wiped into a nozzle.

In an aspect of the present invention, an ink jet printer, comprising a cleaning unit according to any of the above mentioned embodiments is provided.

In a further aspect of the present invention, an inkjet printer comprising a wiper according to one of the above-described embodiments is provided.

In a further aspect of the present invention, a wiper, for use in any of the above mentioned cleaning units is provided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a schematic view of an image forming apparatus;

FIG. 1B is a schematic perspective view of an ink jet printing assembly;

FIGS. 1C and 1D illustrate a nozzle surface, being provided with a wiper according to an embodiment of the present invention;

FIG. 2 is a front view of a wiper according to a first embodiment of the present invention;

FIG. 3 is a further front view of the wiper according to FIG. 2;

FIG. 4 is a front view of a wiper according to a second embodiment of the present invention;

FIG. 5 is a front view of a wiper according to a third embodiment of the present invention;

FIG. 6 is a front view of a wiper according to a fourth embodiment of the present invention;

FIGS. 7A and 7B are a schematic perspective view and a side view, respectively, of a wiper according to an embodiment of the present invention, which is not bent;

FIGS. 7C and 7D are a schematic perspective view and a side view, respectively, of a wiper according to an embodiment of the present invention, which is bent;

FIG. 8 is a top view of a nozzle surface, on which an anti-wetting coating is applied having a wetting gradient;

FIG. 9A is a schematic perspective view of a cleaning unit according to an aspect of the present invention; and

FIG. 9B is a schematic perspective view of a cleaning unit according to an aspect of the present invention.

### DETAILED DESCRIPTION OF THE PREFERRED EMBODIMENTS

The present invention will now be described with reference to the accompanying drawings, wherein the same or similar elements are identified with the same reference numeral.

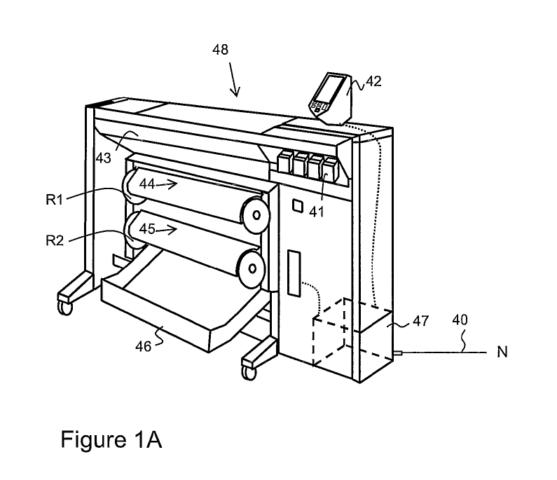

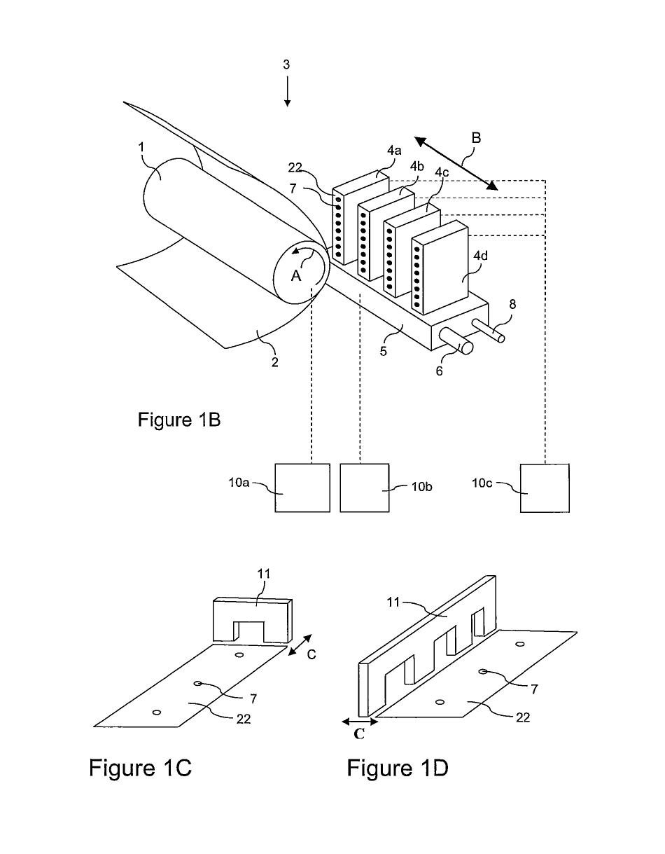

FIG. 1A shows an image forming apparatus 48, wherein printing is achieved using a wide format inkjet printer. The wide-format image forming apparatus 48 comprises a housing 43, wherein the printing assembly, for example the ink jet printing assembly shown in FIG. 1B is placed. The image forming apparatus 48 also comprises a storage device configured to store image receiving member 44, 45, a delivery station to collect the image receiving member 44, 45 after printing and a storage device configured to store marking material 41. In FIG. 1A, the delivery station is embodied as a delivery tray 46. Optionally, the delivery station may comprise a processor configured to process the image receiving member 44, 45 after printing, e.g. a folder or a puncher. The wide-format image forming apparatus 48 furthermore comprises a device configured to receive print jobs and optionally a device configured to manipulate print jobs. These devices may include a user interface unit 42 and/or a control unit 47, for example a computer.

Images are printed on an image receiving member, for example paper, supplied by a roll 44, 45. The roll 44 is supported on the roll support R1, while the roll 45 is supported on the roll support R2. Alternatively, cut sheet image receiving members may be used instead of rolls 44, 45 of the image receiving member. Printed sheets of the image receiving member, cut off from the roll 44, 45, are deposited in the delivery tray 46.

Each one of the marking materials for use in the printing assembly are stored in four containers 41 arranged in fluid connection with the respective print heads for supplying marking material to said print heads.

The local user interface unit 42 is integrated with the print engine and may comprise a display unit and a control panel. Alternatively, the control panel may be integrated with the display unit, for example in the form of a touch-screen control panel. The local user interface unit 42 is connected to a control unit 47 placed inside the printing apparatus 48. The control unit 47, for example a computer, comprises a processor adapted to issue commands to the print engine, for example for controlling the print process. The image forming apparatus 48 may optionally be connected to a network N. The connection to the network N is diagrammatically shown in the form of a cable 40, but nevertheless, the connection could be wireless. The image forming apparatus 48 may receive printing jobs via the network. Further, optionally, the controller of the printer may be provided with a USB port, so printing jobs may be sent to the printer via this USB port.

FIG. 1B shows an ink jet printing assembly 3. The ink jet printing assembly 3 comprises a supporting device configured to support an image receiving member 2. The supporting device is shown in FIG. 1B as a platen 1, but alternatively, the supporting device may be a flat surface. The platen 1, as depicted in FIG. 1B, is a rotatable drum, which is rotatable about its axis as indicated by arrow A. The supporting device may be optionally provided with suction holes for holding the image receiving member in a fixed position with respect to the supporting device. The ink jet printing assembly 3 comprises print heads 4a-4d, mounted on a scanning print carriage 5. The scanning print carriage 5 is guided by a suitable guiding device 6, 8 to move in reciprocation in the main scanning direction B. Each print head 4a-4d comprises a nozzle surface 22, which nozzle surface 22 is provided with at least one nozzle 7. The print heads 4a-4d are configured to eject droplets of marking material onto the image receiving member 2. The platen 1, the carriage 5 and the print heads 4a-4d are controlled by a suitable controlling device 10a, 10b and 10c, respectively.

The image receiving member 2 may be a medium in web or in sheet form and may be composed of, e.g. paper, cardboard, label stock, coated paper, plastic or textile. Alternatively, the image receiving member 2 may also be an intermediate member, endless or not. Examples of endless members, which may be moved cyclically, are a belt or a drum. The image receiving member 2 is moved in the sub-scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image receiving member 2 in the main scanning direction B. Only four print heads 4a-4d are depicted for demonstrating the present invention. In practice an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by the guiding device 6, 8 the guiding device 6, 8 may be rods as depicted in FIG. 1B. The rods may be driven by a suitable driving device (not shown). Alternatively, the carriage 5 may be guided by another guiding device, such as an arm being able to move the carriage 5. Another alternative is to move the image receiving material 2 in the main scanning direction B.

Each print head 4a-4d comprises a nozzle surface 22 having at least one nozzle 7, in fluid communication with a pressure chamber containing fluid marking material provided in the print head 4a-4d. On the nozzle surface 22, a number of nozzles 7 is arranged in a single linear array parallel to the sub-scanning direction A. Eight nozzles 7 per print head 4a-4d are depicted in FIG. 1B, however obviously in a practical embodiment, several hundreds of nozzles 7 may be provided per print head 4a-4d, optionally arranged in multiple arrays. As depicted in FIG. 1B, the respective print heads 4a-4d are placed parallel to each other such that corresponding nozzles 7 of the respective print heads 4a-4d are positioned in-line in the main scanning direction B. This means that a line of image dots in the main scanning direction B may be formed by selectively activating up to four nozzles 7, each of them being part of a different print head 4a-4d. This parallel positioning of the print heads 4a-4d with corresponding in-line placement of the nozzles 7 is advantageous to increase productivity and/or improve print quality. Alternatively multiple print heads 4a-4d may be placed on the print carriage adjacent to each other such that the nozzles 7 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of marking material from the nozzles 7. The image dots are formed by ejecting droplets of ink from the nozzles 7. Upon ejection of the ink, some ink may be spilled and stay on the nozzle surface 22 of the print head 4a-4d. The ink present on the nozzle surface 22 may negatively influence the ejection of droplets, and thus the placement of these droplets on the receiving member 2. Therefore, it is preferred to remove excess ink from the nozzle surface 22. The excess ink may be removed by wiping with a wiper. In general, a wiper contacts (part of) the nozzle surface 22. Hence, when wiping, the wiper engages the ink present on the nozzle surface 22. The ink is moved with the wiper and as a consequence, the ink is removed from the nozzle surface.

FIG. 1C and FIG. 1D show a nozzle surface 22, comprising nozzles 7, provided with a wiper 11 according to an embodiment of the present invention. FIG. 1C shows a nozzle surface 22 and a wiper 11, which wipes a nozzle surface 22 in the direction parallel to a row of nozzles 7, while the wiper as shown in FIG. 1D wipes in a direction perpendicular to a row of nozzles 7, i.e. the direction indicated by the double arrow C.

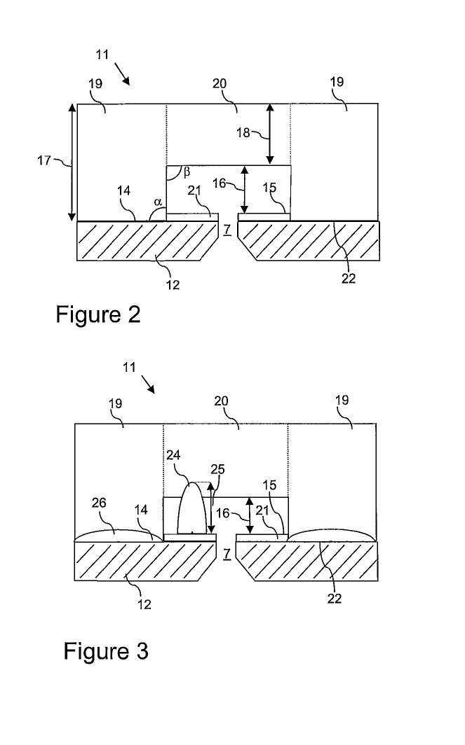

FIG. 2 shows a first embodiment of a wiper 11 according to the present invention and a nozzle plate 12, shown in cross-section, having a nozzle surface 22 and a nozzle 7. Part of the nozzle surface 22 is provided with an anti-wetting coating 21 and is therefore an anti-wetting area 15. A remaining part of the nozzle surface 22 is a wetting area 14. The wiper 11 is shaped such that a wiper area comprises a first wiper subarea 19 and a second wiper subarea 20. The second wiper subarea is arranged at a predetermined distance 16 from the anti-wetting area 15. Angles α and β depicted in FIG. 2 as being 90°, may deviate from the 90° angle.

The first and second wiper subareas 19, 20 have a length and a width. The length of the wiper subareas extends in a direction parallel to the nozzle surface 22. The width of the wiper subareas 19, 20 is perpendicular to the length. The first wiper subarea has a first width 17. The second wiper subarea has a second width 18, which is smaller than the first width 17 of the first wiper subarea 19. As a consequence, in operation, the distance between the second wiper subarea 20 and the nozzle plate 22 is larger than the distance between the first wiper subarea and the nozzle plate 22.

The wiper 11 in operation moves across the nozzle surface 22. The first wiper subarea 19 contacts the wetting area 14, to remove ink from the nozzle surface 12. The second wiper subarea 20 does not contact the nozzle surface 22, thereby preventing damage to the anti-wetting coating 21.

FIG. 3 shows the wiper 11 according to FIG. 2 and a nozzle plate 12, shown in cross-section, having an anti-wetting area 15 and a wetting area 14. In FIG. 3, ink is present on both the anti-wetting area 15 and the wetting area 14. On the wetting area 14, ink is present as a film of ink 26. On the anti-wetting area 15, ink is present as a droplet 24, having a height 25. The height 25 of the droplet 24 is larger than the predetermined distance 16 between the anti-wetting area 15 of the nozzle surface 22 and the second wiper subarea 20.

The first wiper subarea 19 in operation engages the ink film 26 present on the wetting area 14 of the nozzle surface 22. Because of the higher wettability of the wetting area 14, ink spreads over the area, forming a thin film of ink. Because the film 26 is thin, a wiper area arranged at a distance from the nozzle surface 22 would not be able to engage the film of ink 26 and remove the ink from the surface 22. Therefore, the first wiper area 19 is shaped such that it contacts the wetting area 14 of the nozzle surface 22. The anti-wetting area 15 of the nozzle surface 22 on the other hand, has a poor wettability. Hence, ink present on the anti-wetting area 15 forms a droplet 24, having a small contact area with the anti-wetting area 15. The second wiper area 20 is arranged at the predetermined distance 16 from the anti-wetting area 15. The wiper 11 is shaped such that the predetermined distance 16 is smaller than the height 25 of the droplet 24 and such that the second wiper subarea 20 does not contact the anti-wetting area 15. As a consequence, the second wiper subarea 20 in operation may engage a droplet 24 of ink on the anti-wetting area 15 and remove the droplet 24 from the nozzle surface 22 without contacting the anti-wetting area 15 of the nozzle surface 22, thereby preventing damage to the anti-wetting coating 21.

It is noted that in another embodiment the predetermined distance 16 may be larger than the height 25 of the droplet 24, such that the droplet 24 is not contacted by the wiper 11.

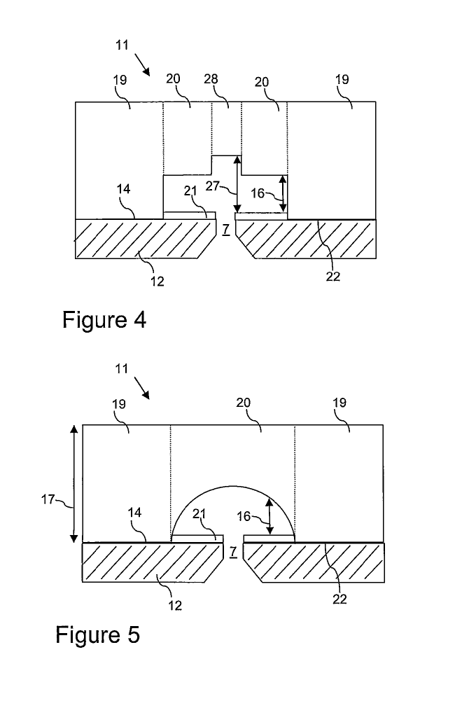

FIG. 4 shows a wiper 11 according to a second embodiment of the present invention and a nozzle plate 12, shown in cross-section, having a wetting area 14 and an anti-wetting area 15. The wiper 11, as shown in FIG. 4 has a wiping surface, which comprises a first wiper subarea 19, a second wiper subarea 20 and a third wiper subarea 28. The first wiper subarea 19 in operation contacts the wetting area 14 of the nozzle surface 22. The second wiper subarea 20 is arranged at a first predetermined distance 16 from the anti-wetting area 15. The third wiper subarea 28 is arranged at a second predetermined distance 27 from the anti-wetting area 15. The second predetermined distance 27 is larger than the first predetermined distance 16.

The wiper 11 in operation moves across the nozzle surface 22. The first wiper subarea 19 contacts the wetting area 14 and moves ink present on the wetting area 14 from the nozzle surface 22. If the first predetermined distance 16 is smaller than the height 25 of a droplet 24, then the second wiper subarea 20 engages ink present on the anti-wetting area 15 and removes the ink from the nozzle surface 22. If the second predetermined distance 27 is larger than the height 25 of a droplet 24, then the third wiper subarea 28 does not engage a droplet of ink 24 and does not remove the droplet 24 from the nozzle surface 22.

The third wiper subarea 28 is positioned such that it traverses in operation a nozzle 7. Since the second predetermined distance 27 is larger than the height 25 of a droplet 24, the droplet 24 is not engaged by the third wiper subarea 28 and is therefore prevented from being wiped into a nozzle 7. Wiping ink into a nozzle 7 may negatively influence the properties of a nozzle 7 and therefore of the print head 3.

The first wiper subarea 19 and the second wiper subarea 20 are arranged such that they do not traverse in operation a nozzle 7. The first wiper subarea 19 and second wiper subarea 20 do in operation engage ink. As a consequence, ink is removed from the nozzle surface 22, but no ink is wiped into a nozzle 7.

FIG. 5 shows a wiper 11 according to an embodiment of the present invention and a nozzle plate 12, shown in cross-section, having a wetting area 14 and an anti-wetting area 15. The wiper 11 has a first wiper subarea 19 and a second wiper subarea 20. The first wiper subarea 19 in operation contacts the wetting area 14. The second wiper subarea 20 is arranged at a predetermined distance 16 from the anti-wetting area 15. In FIG. 5, the predetermined distance 16 is not constant, but varies with the distance from the wetting area 14 and is smallest at the border of the anti-wetting area 15 and the wetting area 14.

The wiper 11 in operation moves across the nozzle surface 22. The first wiper subarea 19 contacts the wetting area 14 and moves ink present on the wetting area 14 from the nozzle surface 22. The second wiper area is arranged at a first predetermined distance 16 from the anti-wetting area 15. If the predetermined distance 16 is larger than the height 25 of a droplet 24, then the wiper subarea will engage ink present on the anti-wetting area 15 and remove the ink from the nozzle surface 22.

In a region of the second wiper subarea 20, the predetermined distance 16 may be higher that the height 25 of a droplet 24 of ink. The predetermined distance 16 is largest above a nozzle 7. As a consequence, by providing an appropriate maximum predetermined distance (predetermined distance 16 above a nozzle), the second wiper subarea 20 may be arranged such that a part of the anti-wetting area 15 is wiped by said second wiper subarea 20, but no ink is wiped into a nozzle 7. In that case, a droplet 24 of ink is prevented from being wiped into a nozzle 7, but a part of the droplets 24 present on the anti-wetting area 15 may still be removed from the nozzle surface 22 by the part of the second wiper area 20 that is positioned at a predetermined distance 16 that is smaller than the height 25 of a droplet 24.

This design of the wiper may be advantageous for manufacturing considerations, for example.

It is noted that a wiper according to the present invention may be employed in combination with a nozzle surface not having a coating arranged thereon. For example, for preventing dirt or ink from being wiped into a nozzle, a wiper according to the present invention may comprise a wiper subarea arranged at a predetermined distance from the nozzle surface such that the wiper does not wipe a part of the nozzle surface surrounding a nozzle, as above described, for the second wiper subarea 20 as illustrated in FIG. 5.

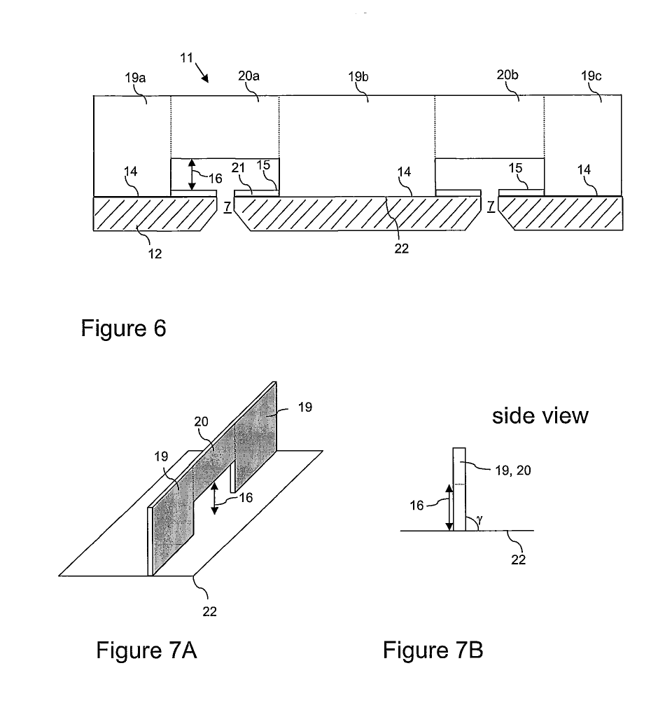

FIG. 6 shows a wiper 11 according to an embodiment of the present invention and a nozzle surface 22, shown in cross-section, having a wetting area 14 and an anti-wetting area 15. The wiper 11 has a first wiper subareas 19a, a third wiper subarea 19b and a fifth wiper subarea 19c that contact the wetting areas 14 and a second wiper subarea 20a and a fourth wiper subarea 20b arranged at a predetermined distance 16 from the anti-wetting area 15. The nozzle plate 12 has a plurality of nozzles 7.

The wiper 11 in operation moves across the nozzle surface 22. The first wiper subarea 19a, the third wiper subarea 19b and the fifth wiper subarea 19c contact the wetting areas 14, to remove ink from the nozzle surface 22. The second wiper subarea 20a and the fourth wiper subarea 20b do not contact the nozzle surface 22, thereby preventing damage to the anti-wetting coating 21. The shape of the wiper 11 enables wiping around a plurality of nozzles 7 in one wiping operation and thus, efficiently removing ink.

Although only two (rows of) nozzles 7 are depicted in FIG. 6, it will be clear to the person skilled in the art, that the nozzle plate 12 may comprise an arbitrary amount of nozzles 7 and that the wiper 11 may comprise an arbitrary amount of wiper subareas that contact the wetting areas 14 and an arbitrary amount of wiper subareas that are arranged at a predetermined distance 16 from the anti-wetting area 15.

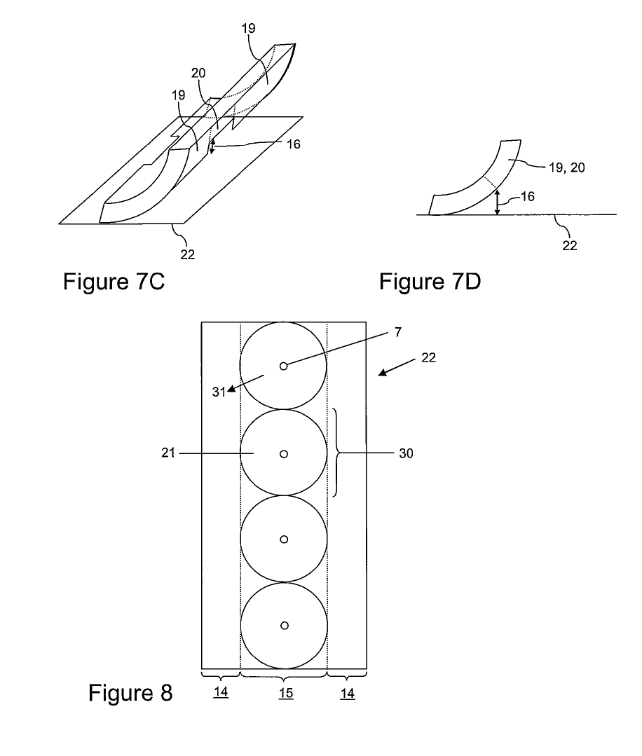

FIG. 7A shows a perspective view of a wiper 11 according to an embodiment of the present invention on a nozzle surface 22. The wiper 11 comprises a first wiper subarea 19 and a second wiper subarea 20. The first wiper subarea 19 contacts the nozzle surface 22, whereas the second wiper subarea 20 is arranged at a predetermined distance 16 from the nozzle surface 22. The wiper areas 19, 20 are arranged substantially perpendicular to the nozzle surface 22.

FIG. 7B shows a side view of the wiper 11 and the nozzle surface 22 as described in FIG. 7A. The angle γ is shown as being substantially 90°, but may deviate from 90°.

FIG. 7C shows a perspective view of a wiper 11 according to an embodiment of the present invention on a nozzle surface 22, shown in cross section. The wiper 11 comprises a first wiper subarea 19 and a second wiper subarea 20. The first wiper subarea 19 contacts the nozzle surface 22, whereas the second wiper subarea 20 is arranged at a predetermined distance 16 from the nozzle surface 22. The wiper is bent. Because the wiper 11 is bent, the predetermined distance 16 is smaller than in the case where the wiper 11 is not bent (FIG. 7A and FIG. 7B).

FIG. 7D shows a side view of the bent wiper 11, as shown in FIG. 7C.

The first wiper subarea 19 of the wiper as shown in FIG. 7A and FIG. 7B in operation contacts the nozzle surface 22 and engages in operation ink to remove the ink from the nozzle surface 22. The second wiper area 20 is arranged at a predetermined distance 16 from the nozzle surface 22 and may engage in operation droplets of ink and remove these from the nozzle surface 22.

The wiper 11, as shown in FIG. 7C and FIG. 7D may be bent by applying a force in a direction substantially perpendicular to the nozzle surface 22. The extent, to which the wiper 11 is bent influences the predetermined distance 16. Consequently, the magnitude of the force, applied on the wiper 11 in a direction substantially perpendicular to the nozzle surface 22, influences the predetermined distance 16. If the second wiper subarea 20 is not supposed to remove any droplets 24 from the anti-wetting area 15, then the predetermined distance 16 may be adjusted to be larger than the height 25 of a droplet 24. This may be done by applying no force or a small force onto the wiper 11. If the second wiper subarea 20 is supposed to remove any droplets 24 from the anti-wetting area 15, then the predetermined distance 16 may be adjusted to be smaller than the height 25 of a droplet 24. This may be done by applying a force onto the wiper.

If the second wiper subarea is supposed to contact the anti-wetting area 15, then the predetermined distance may be adjusted to be zero. This may be done by applying a large force onto the wiper 11.

FIG. 8 shows a top view of a nozzle surface 22, on which an anti-wetting coating 21 is applied with a wetting gradient 30. The part of the nozzle surface 22, on which an anti-wetting coating 21 is applied is an anti-wetting area 15. The anti-wetting coating is applied in a pattern around a nozzle 7. The pattern is such that a gradient is experienced by ink present on the nozzle surface 22.

The pattern of anti-wetting coating 21 forms a wetting gradient 30. The wetting-gradient 30 provides a driving force 31 for ink to migrate away from a nozzle 7. As a consequence, although only a part of the nozzle surface 22 in between the wetting areas 14 is provided with an anti-wetting coating 21, ink moves away from the anti-wetting area 15 to the wetting area 14 of the nozzle surface 22. A wiper according to the present invention may of course be suitably employed on such a nozzle surface.

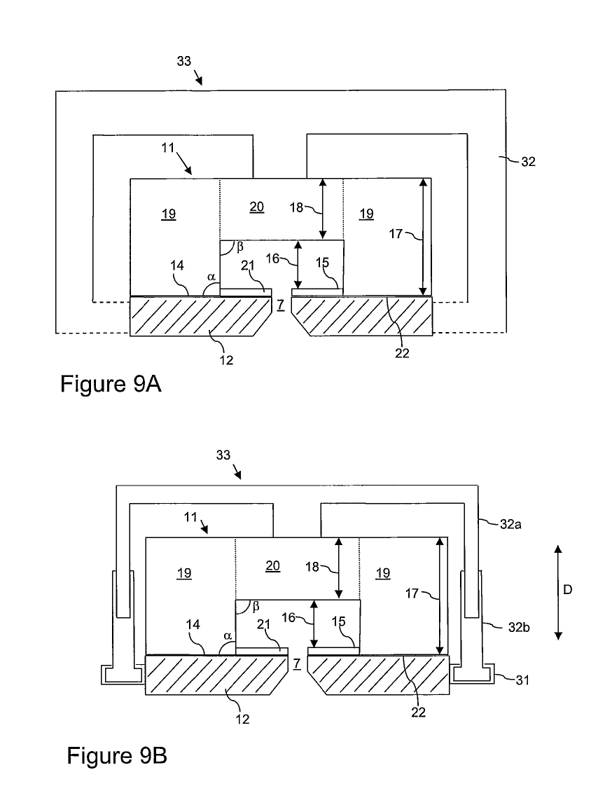

FIG. 9A shows a schematic representation of a cleaning unit 33 in accordance with the present invention. The cleaning unit 33 comprises a positioning device 32 and a wiper 11. The positioning device 32 engages the wiper 11, such that the wiper 11 may be suitably positioned with respect to the nozzle surface 22. The positioning device 32, as shown in FIG. 9A, engages the second wiping subarea 20. Alternatively, the positioning device may engage only the first wiping subarea 19 or both the first wiping subarea 19 and the second wiping subarea 20, or even another part of the wiper (not shown). The positioning device 32 may be connected to the nozzle plate 12, in order to suitably position the wiper 11 with regard to the nozzle surface 22, or the positioning device 32 may be connected to another part of a printing device, as long as the positioning device 32 may position the wiper 11 suitably with regard to the nozzle surface 14, as is depicted with dashed lines. The positioning device 32 may position the wiper 11 with respect to the nozzle surface 22 at the desired height (predetermine distance 16), in the scanning direction B, for example to guide the wiper over the nozzle surface 22 in a wiping operation, or in a lateral position. Alternatively, the positioning device 32 may position the wiper 11 in the sub scanning direction A. The wiper may be positioned in a fixed position with respect to the nozzle surface 22 in sub scanning direction A. Alternatively, the print head 3 may comprise several rows of nozzles 7 extending in a direction parallel to the sub scanning direction A and the wiper 11 may be adjustably positioned with respect to the plurality of rows of nozzles 7 extending in the sub scanning direction A. To position the wiper 11 with respect to the nozzle surface 22, the positioning device 32 is connected to the nozzle plate 12, or to a part of a printer connected to the nozzle plate 22.

FIG. 9B shows a cleaning unit 33 in accordance with the present invention. The cleaning unit 33 comprises a wiper 11 and positioning device 32. The positioning device 32 engages the wiper 11 and positions the wiper 11 with respect to the nozzle surface 14. The positioning device 32, as shown in FIG. 9B, consists of two parts: an upper part 32a and a lower part 32b. The upper part 32a, as shown in FIG. 9B, is a holder, holding the wiper 11 at the desired position with respect to the nozzle surface 22. The holder 32a is movably connected to the lower part 32b of the positioning device 32 and may be moved in reciprocation in direction D with respect to the lower part 32b of the positioning device 32. This may be done by providing, for example a worm wheel, a linear servo controlled motor or pneumatic actuation between the holder and the lower part 32b of the positioning device. The lower part 32b of the positioning device 32 is engaged by guiding device 31. The guiding device 31 positions the lower part 32b of the positioning device 32 with respect to the nozzle surface 14. The guiding device 31, as shown, is connected to the nozzle plate 12. However, alternatively, the guiding device may be connected to a different part of the print head 3 or even of the printer, as long as the wiper 11 is suitably positioned with respect to the nozzle surface 22. The guiding device 31 may guide the positioning device 32 when the positioning device 32 engaging the wiper 31 is moved in a direction perpendicular to the plane of the drawing to wipe the nozzle surface 14. As mentioned above, the upper part 32a of the positioning device 32 may be moved with respect to the lower part 32b of the positioning device. By doing so, the predetermined distance 16 may be suitably controlled. The cleaning unit 33, comprising at least the positioning device 32 and the wiper 11 are driven by a suitable driving device (not shown).

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims is herewith disclosed.

Further, the terms and phrases used herein are not intended to be limiting; but rather, to provide an understandable description of the present invention. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wiper for wiping a nozzle surface, comprising:
a wiper area, the wiper area being shaped such that it comprises:
a first wiper subarea that in operation contacts a part of the nozzle surface; and
a second wiper subarea that in operation is arranged at a predetermined distance from another part of the nozzle surface.

2. The wiper according to claim 1, wherein the nozzle surface comprises a wetting area and an anti-wetting area, the first wiper subarea in operation contacting at least a part of the wetting area and the second wiper subarea in operation being arranged at a predetermined distance from at least a part of the anti-wetting area.

3. The wiper according to claim 1, wherein the predetermined distance is such that a droplet present on the nozzle surface is in operation removed by wiping with said wiper.

4. The wiper according to claim 1, further comprising a front surface, the front surface having a length and a width, the length extending in operation substantially parallel to the nozzle surface and the width extending perpendicular to the length,
wherein the width of the front surface of the second wiper subarea is smaller than the width of the front surface of the first wiper subarea.

5. The wiper according to claim 1, wherein the predetermined distance is adjustable.

6. The wiper according to claim 2, wherein the predetermined distance is larger than the height of a droplet of ink on the anti-wetting area.

7. The wiper according to claim 2, wherein the predetermined distance is a first predetermined distance smaller than the height of a droplet of ink on the anti-wetting area and wherein the wiper area further comprises a third wiper subarea arranged at a second predetermined distance from the nozzle surface larger than the height of a droplet of ink.

8. An inkjet printer, comprising a wiper according to claim 1 for cleaning the nozzle face of an inkjet print head.
